(19) United States
(12) Patent Application Publication
(10) Pub. No.: US 2008/0182525 A1
(43) Pub. Date: Jul. 31, 2008

(54) On-chip inductor, integrated circuit and methods for use therewith

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/700,807

(22) Filed: Jan. 30, 2007

(51) Int. Cl. H04B 1/40

(52) U.S. Cl. 455/77

(57) ABSTRACT

An on-chip inductor includes a first turn on a first dielectric layer and a via, coupled to the first turn. A second turn on a second dielectric layer, is coupled to the first dielectric layer and via. The first dielectric layer includes at least one removed dielectric section where a portion of the first dielectric is removed between the first turn and the second turn, improving the magnetic coupling between the first turn and the second turn.

### CROSS-REFERENCE TO RELATED APPLICATIONS

None

### BACKGROUND OF THE INVENTION

1. Technical Field of the Invention

This invention relates generally to wireless communications systems and more particularly to radio transceivers used within such wireless communication systems.

2. Description of Related Art

Communication systems are known to support wireless and wire line communications between wireless and/or wire line communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna through an antenna interface and includes a low noise amplifier, one or more intermediate frequency stages, a filtering stage, and a data recovery stage. The low noise amplifier (LNA) receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

It is desirable to incorporate as many of the components the wireless communication device on a single integrated circuit as possible. Certain components, such as inductors, provide special challenges given the physical dimensions required to produce these components. Better and more efficient on-chip inductors are required that use less space on an integrated circuit.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a wireless communication system in accordance with the present invention.

FIG. 2 is a schematic block diagram of a wireless communication system in accordance with the present invention.

FIG. 3 is a schematic block diagram of a wireless communication device 10 in accordance with the present invention.

FIG. 4 is a schematic block diagram of a wireless communication device 30 in accordance with the present invention.

FIG. 5 is a schematic block diagram of an RF transceiver 125 in accordance with the present invention.

FIG. 6 is a schematic block diagram of an antenna interface 171 that incorporates an on-chip inductor in accordance with an embodiment of the present invention.

FIG. 7 is a top view of an inductor 310 in accordance with the present invention.

FIG. 8 is a side view of an inductor 310 in accordance with the present invention.

FIG. 9 is a bottom view of an inductor 310 in accordance with the present invention.

FIG. 10 is a top view of an inductor 310 in accordance with a further embodiment of the present invention.

FIG. 11 is a top view of an inductor 330 in accordance with the present invention.

FIG. 12 is a side view of an inductor 330 in accordance with the present invention.

FIG. 13 is a bottom view of an inductor 330 in accordance with the present invention.

FIG. 14 is a flowchart representation of a method in accordance with an embodiment of the present invention.

### DETAILED DESCRIPTION OF THE INVENTION

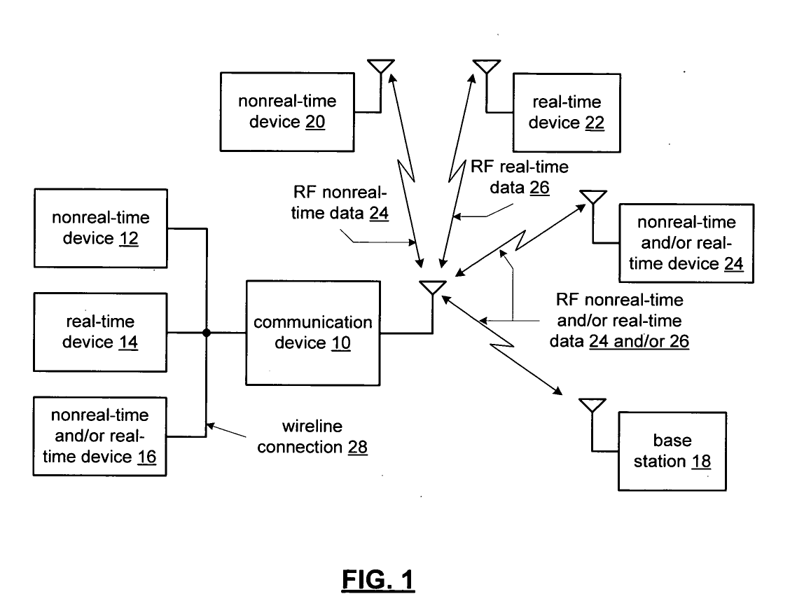

FIG. 1 is a schematic block diagram of an embodiment of a communication system in accordance with the present invention. In particular a communication system is shown that includes a communication device 10 that communicates real-time data 24 and/or non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

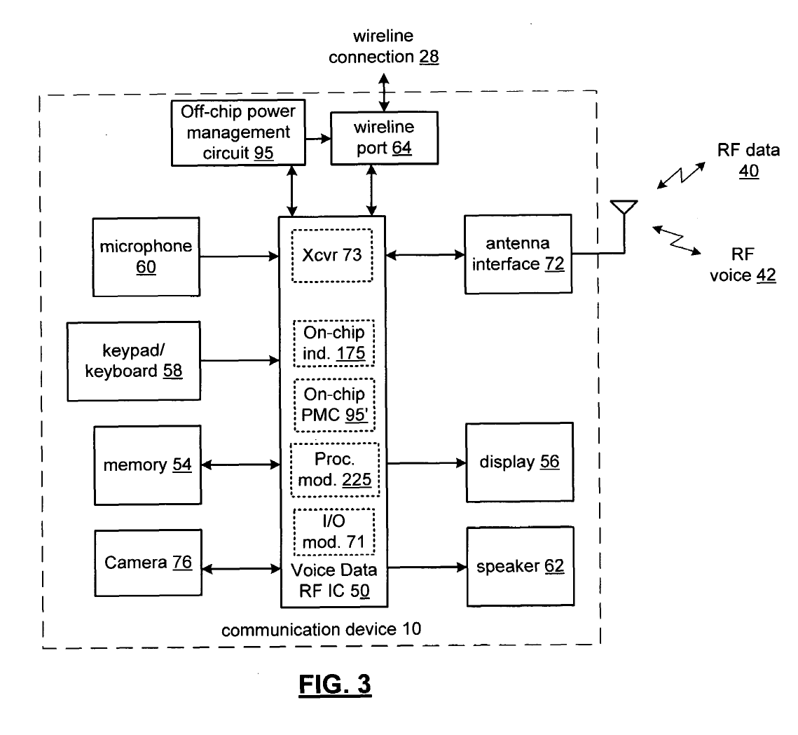

In an embodiment of the present invention, the communication device 10 includes an integrated circuit, such as a combined voice, data and RF integrated circuit that includes one or more features or functions of the present invention. Such integrated circuits shall be described in greater detail in association with FIGS. 3-19 that follow.

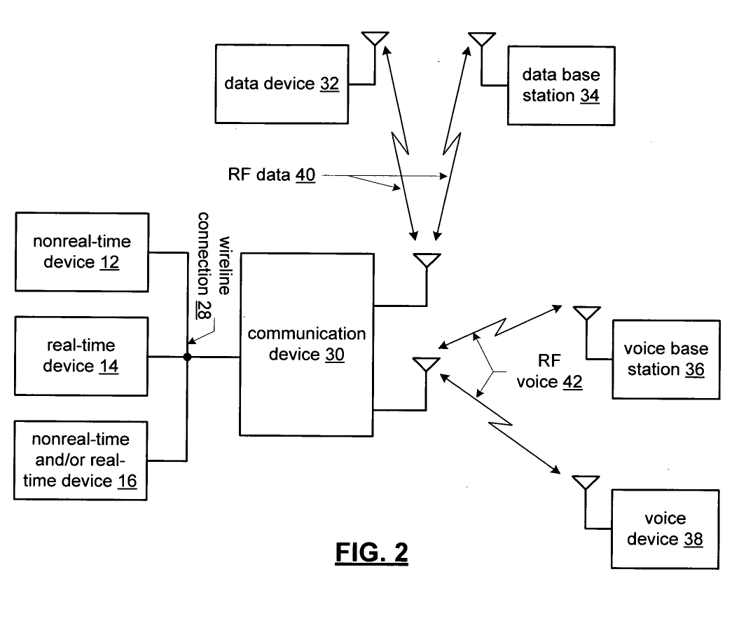

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes two separate wireless transceivers for communicating, contemporaneously, via two or more wireless communication protocols with data device 32 and/or data base station 34 via RF data 40 and voice base station 36 and/or voice device 38 via RF voice signals 42.

FIG. 3 is a schematic block diagram of an embodiment of an integrated circuit in accordance with the present invention. In particular, a voice data RF integrated circuit (IC) 50 is shown that implements communication device 10 in conjunction with microphone 60, keypad/keyboard 58, memory 54, speaker 62, display 56, camera 76, antenna interface 52 and wireline port 64. In addition, voice data RF IC 50 includes a transceiver 73 with RF and baseband modules for formatting and modulating data into RF real-time data 26 and non-real-time data 24 and transmitting this data via an antenna interface 72, and antenna. Further, voice data RF IC 50 includes an input/output module 71 with appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Off-chip power management circuit 95 includes one or more DC-DC converters, voltage regulators, current regulators or other power supplies for supplying the voice data RF IC 50 and optionally the other components of communication device 10 and/or its peripheral devices with supply voltages and or currents (collectively power supply signals) that may be required to power these devices. Off-chip power management circuit 95 can operate from one or more batteries, line power and/or from other power sources, not shown. In particular, off-chip power management module can selectively supply power supply signals of different voltages, currents or current limits or with adjustable voltages, currents or current limits in response to power mode signals received from the voice data RF IC 50. Voice Data RF IC 50 optionally includes an on-chip power management circuit 95′ for replacing the off-chip power management circuit 95.

In an embodiment of the present invention, the voice data RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the Voice Data RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

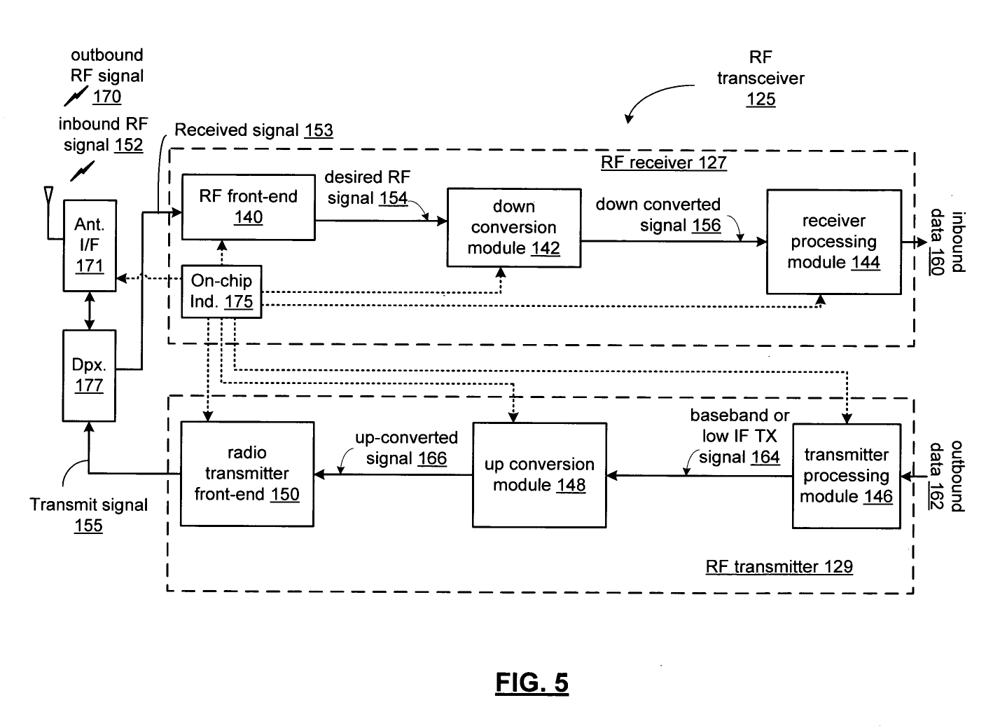

In operation, the voice data RF IC 50 executes operational instructions that implement one or more of the applications (real-time or non-real-time) attributed to communication devices 10 and 30 as discussed in conjunction with FIGS. 1 and 2. Further, RF IC 50 includes an on-chip inductor 175 that provide a component used for tuning the antenna by coupling to the antenna interface 72, in a voltage controlled oscillator, mixer or filter of transceiver 73 or for use in one or more other modules of voice, data RF IC 50, as will be discussed in greater detail in association with the description that follows, and particularly in conjunction with FIGS. 5-14.

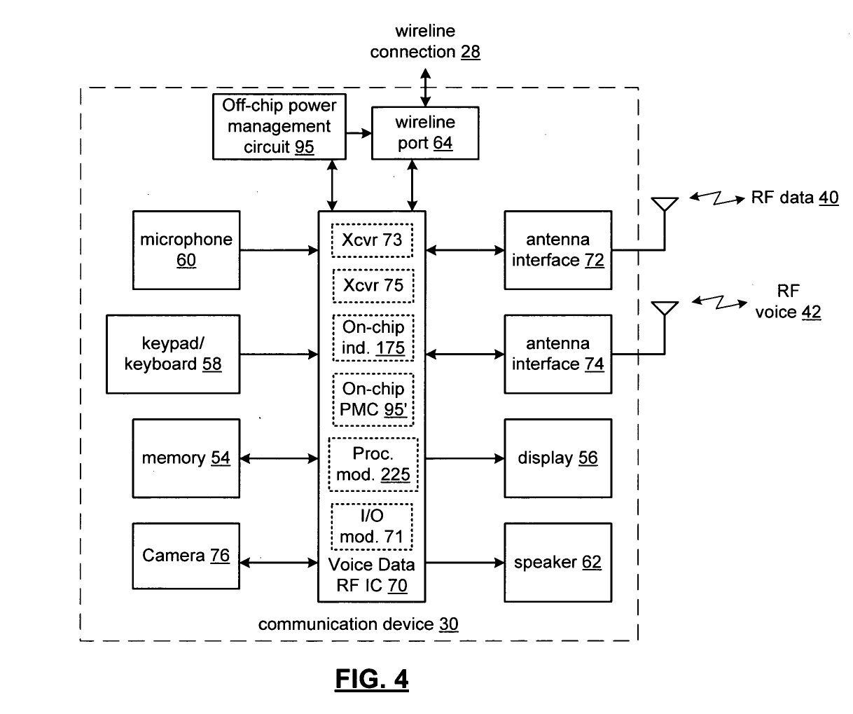

FIG. 4 is a schematic block diagram of another embodiment of an integrated circuit in accordance with the present invention. In particular, FIG. 4 presents a communication device 30 that includes many common elements of FIG. 3 that are referred to by common reference numerals. Voice data RF IC 70 is similar to voice data RF IC 50 and is capable of any of the applications, functions and features attributed to voice data RF IC 50 as discussed in conjunction with FIG. 3. However, voice data RF IC 70 includes two separate wireless 73 and 75 for communicating, contemporaneously, via two or more wireless communication protocols via RF data 40 and RF voice signals 42.

In operation, the voice data RF IC 70 executes operational instructions that implement one or more of the applications (real-time or non-real-time) attributed to communication device 10 as discussed in conjunction with FIG. 1. Further, RF IC 70 includes an on-chip inductor 175 that provide a component used for tuning the antenna by coupling to the antenna interface 72, in a voltage controlled oscillator, mixer or filter of transceiver 73 and/or 75 or for use in one or more other modules of voice, data RF IC 50, as will be discussed in greater detail in association with the description that follows, and particularly in conjunction with FIGS. 5-14.

FIG. 5 is a schematic block diagram of an RF transceiver 125, such as transceiver 73 or 75, which may be incorporated in communication devices 10 and/or 30. The RF transceiver 125 includes an RF transmitter 129, an RF receiver 127 and an on-chip inductor 175. The RF receiver 127 includes a RF front end 140, a down conversion module 142, and a receiver processing module 144. The RF transmitter 129 includes a transmitter processing module 146, an up conversion module 148, and a radio transmitter front-end 150.

As shown, the receiver and transmitter are each coupled to an antenna through an off-chip antenna interface 171 and a diplexer (duplexer) 177, that couples the transmit signal 155 to the antenna to produce outbound RF signal 170 and couples inbound signal 152 to produce received signal 153. While a single antenna is represented, the receiver and transmitter can each have a dedicated antenna, or each use or share a multiple antenna structure that includes two or more antennas. In another embodiment, the receiver and transmitter may share a multiple input multiple output (MIMO) antenna structure that includes a plurality of antennas. Each of these antennas may be fixed, programmable, and antenna array or other antenna configuration. Accordingly, the antenna structure of the wireless transceiver will depend on the particular standard(s) to which the wireless transceiver is compliant and the applications thereof.

In operation, the transmitter receives outbound data 162 from a host device or other source via the transmitter processing module 146. The transmitter processing module 146 processes the outbound data 162 in accordance with a particular wireless communication standard (e.g., IEEE 802.11, Bluetooth, RFID, GSM, CDMA, et cetera) to produce baseband or low intermediate frequency (IF) transmit (TX) signals 164. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further note that the transmitter processing module 146 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 146 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up converted signals 166 based on a transmitter local oscillation 168.

The radio transmitter front end 150 includes a power amplifier and may also include a transmit filter module. The power amplifier amplifies the up converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration.

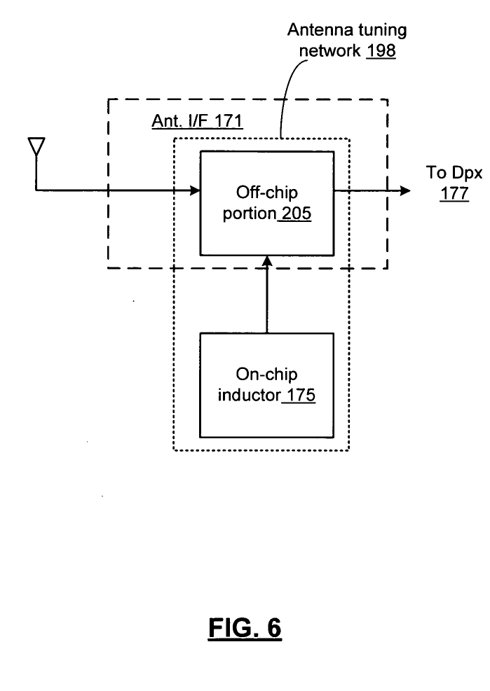

The receiver receives inbound RF signals 152 via the antenna and off-chip antenna interface 171 that operates to process the inbound RF signal 152 into received signal 153 for the receiver front-end 140. In general, antenna interface 171 provides tuning of the antenna, impedance matching of antenna to the RF front-end 140 and/or optional bandpass filtration of the inbound RF signal 152. This interface can be coupled to on-chip inductor 175, as will be discussed in greater detail in conjunction with FIG. 6.

The down conversion module 70 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound data 160. The processing performed by the receiver processing module 144 includes, but is not limited to, digital intermediate frequency to baseband conversion, demodulation, demapping, depuncturing, decoding, and/or descrambling. Note that the receiver processing modules 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The on-chip inductor 175 is an inductor, such as a high quality on-chip inductor that is implemented on several layers of the voice data RF IC 50 and/or 70, with selected dielectric portions being removed between turns to increase the magnetic coupling and to produce an inductor with a higher quality factor (Q). The on-chip inductor 175 can be coupled to antenna interface 171 as previously discussed or used as a component in the RF front end 140, down conversion module 142, receiver processing module 144, radio transmitter front-end 150, up conversion module 148 or transmitter processing module 146. In particular, on-chip inductor 175 can be used as a component in any of a wide range of circuits including filters, tank circuits, voltage controlled oscillators, choke circuits, mixers, noise suppression circuits and/or other circuit implementations that employ an inductor.

FIG. 6 is a schematic block diagram of an antenna interface 171 that incorporates an on-chip inductor in accordance with an embodiment of the present invention. In particular, antenna interface 171 includes an off-chip portion 205 that includes a coupling to on-chip inductor 175 to form antenna tuning network 198. This antenna tuning network can consist of only the on-chip inductor 175 and the coupling of off-chip portion 205 to tune the resonant frequency or other operating frequency of the antenna formed by antenna tuning network 198 operating in conjunction with the attached antenna element. In the alternative, off-chip portion 205 can include other circuit components such as one or more other inductors, and/or transformers, capacitors, tank circuits or other circuit elements that combine with the on-chip inductor 175 to form impedance matching networks in a L-network, T-network, pi-network, balun, or other network configuration and to form an optional bandpass filter or other filter.

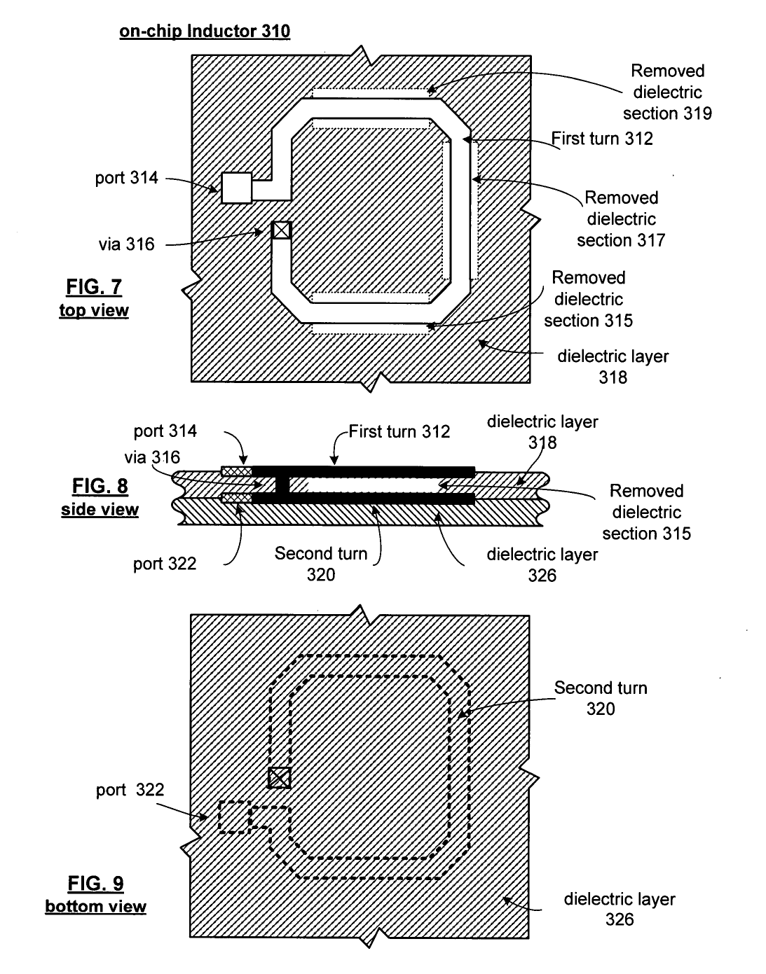

FIGS. 7-9 illustrate a top, side, and bottom view of an on-chip inductor 310, such as on-chip inductor 175. FIG. 7 is a top view of on-chip inductor 310 in accordance with the present invention. In particular, the first turn 312 is created by a conductor on a dielectric layer 318. The first turn 312 terminates at port 314 and is coupled to a second turn 320 by via 316. The second turn is positioned below the first turn as will be shown in FIG. 9. The dielectric layer 318 includes removed dielectric sections 315, 317 and 319 where a portion of the dielectric is removed between the first turn 312 and the second turn 320 to improve the magnetic coupling between the first turn 312 and the second turn 320. This can improve the quality factor and/or modify other inductor characteristics of the on-chip inductor 310. The size of the first turn 312, the width of the conductive material utilized to implement the first turn 312 is dependent on the desired inductance of the on-chip inductor 310, the total number of turns, the current requirements, and desired quality factor, etc. In should be noted the dimensions, shape, configuration and number of the removed dielectric sections can be chosen to provide the necessary structural support of the first turn 312. As shown the removed dielectric sections 315, 317 and 319 are separated by portions of the dielectric layer 318 that are retained to provide support for the first turn 312.

The creation of a first turn 312, via 316 and port 314 on a dielectric layer 318 may be created by etching, depositing, and/or any other method for fabricating components on an integrated circuit. In addition, the removed dielectric sections 315, 317, and 319 can be removed using a microelectromechanical systems (MEMS) technology such as dry etching, wet etching, electro discharge machining, or using other integrated circuit fabrication techniques.

FIG. 8 is a side view of an inductor 310 in accordance with the present invention. As shown, the dielectric layer 318 supports the first turn 312, ports 314 and via 316. Underneath dielectric layer 318 is dielectric layer 326, which supports second turn 320 and port 322. Is discussed above, the first and second turns have improved magnetic coupling because of removed dielectric section 315 and the other removed dielectric sections 317 and 319.

FIG. 9 is a bottom view of an inductor 310 in accordance with the present invention. As shown, the second turn 220 has a similar shape to first turn 312 and forms a two turn inductor between ports 314 and 322. While two turns 312, 320 are shown on two dielectric layers 318, 326, additional turns can be implemented on additional layers in accordance with the present invention to increase the inductance of on-chip inductor 310.

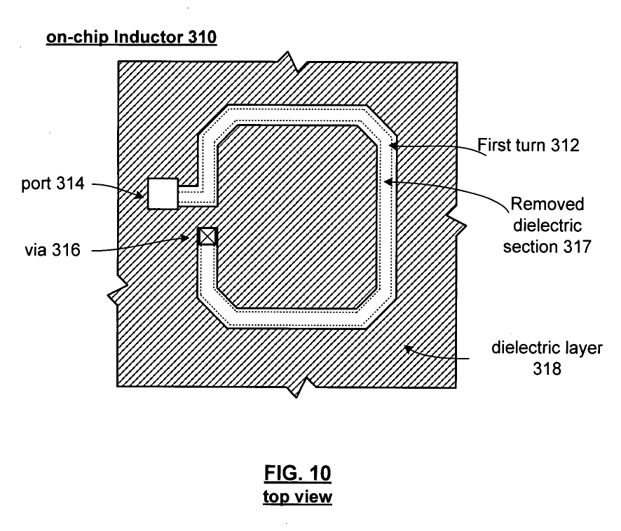

FIG. 10 is a top view of an inductor 310 in accordance with a further embodiment of the present invention. This corresponds to an alternative implementation of inductor 310 with similar elements being referred to by common reference elements, and similar structures for the second turn 320 and second dielectric 326. In this embodiment however, a single removed dielectric section 317 tunnels below the conductor of the first turn 312. As shown, a portion of the dielectric layer 318 remains to support first turn 312 from below, however, this support may be optionally removed if the conductor that comprises first turn 312 is bonded to a layer above. While not shown, the removed dielectric section 317 may include addition removed portions to facilitate the removal by the particular technology employed.

FIGS. 11-13 present an on-chip inductor 330, such as on-chip inductor 175 in accordance with a further embodiment of the present invention. In particular, this embodiment includes a plurality of first turns on a first dielectric layer coupled by a metal bridges on an intermediate dielectric layer. Similarly, a plurality of second turns are included on the second dielectric layer coupled by a metal bridge on a dielectric layer below. In this structure, the removed dielectric section includes a portion where the intermediate dielectric layer is removed between the first turn and the second turn along with the first dielectric layer. In the embodiment shown, the plurality of first and second turns each include an interwoven spiral-type winding.

FIG. 11 is a top view of an inductor 330 in accordance with the present invention. As shown, the first turns 332 includes metal bridges 334 and 336 to couple various sections of the winding together. The first turn is on dielectric layer 338, while the metal bridges 334 and 336 are on a lower dielectric layer, which enables the first turns to maintain their symmetry. One possible configuration for removed dielectric sections 333 and 335 are shown that provides greater magnetic coupling to the second turns that are below.

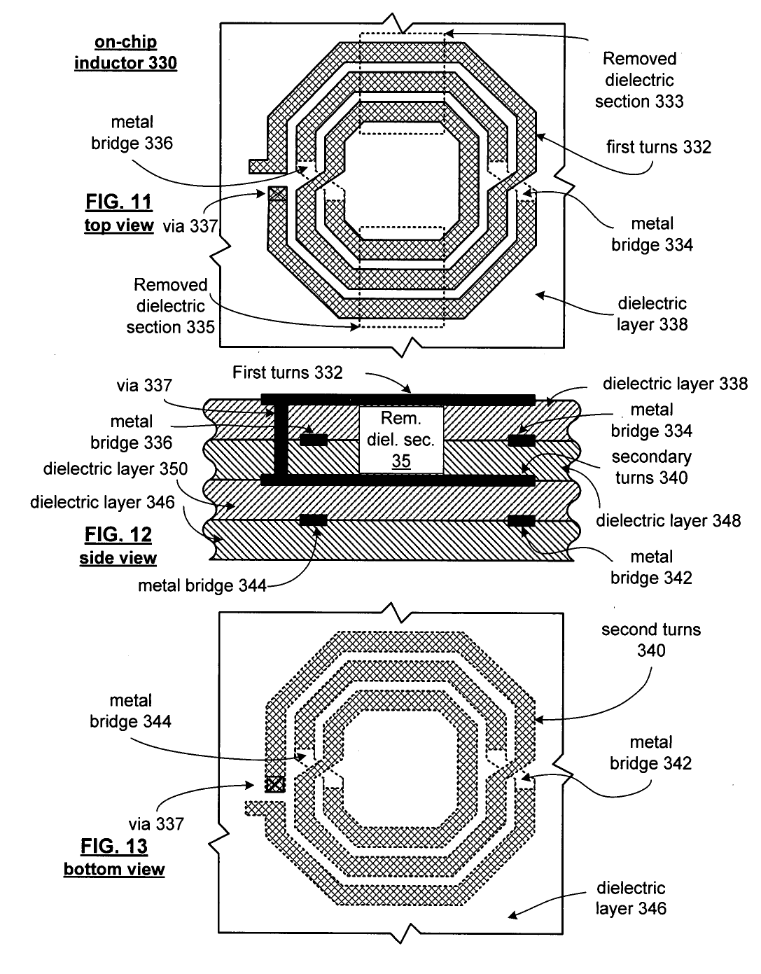

FIG. 12 is a side view of an inductor 330 in accordance with the present invention. As shown, dielectric layer 338 supports the first turns 332. A lower layer, dielectric layer 348, supports metal bridges 334 and 336. Utilizing conventional integrated circuit technologies, the metal bridges 334 and 336 are coupled to the corresponding portions of the first turns 332. As further shown, dielectric layer 350 supports the second turns 340 while dielectric layer 346 supports the metal bridges 342 and 344. The first turns 332 and the second turns 340 are coupled together by via 337. As discussed above, removed dielectric section 335 removes portions of both dielectric layers 338 and 348 to improve the magnetic coupling between the first turns 332 and second turns 340.

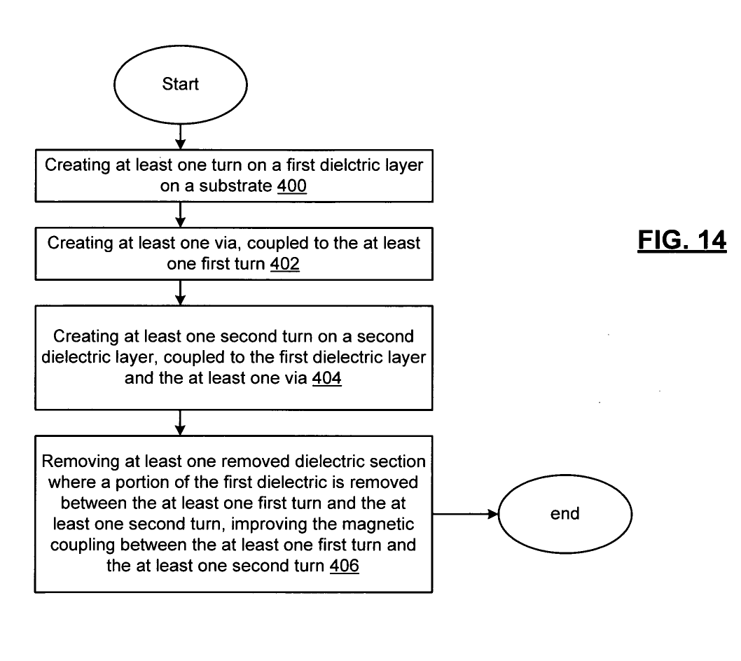

FIG. 13 is a bottom view of an inductor 330 in accordance with the present invention. As shown, the second turn 340 on dielectric layer 346 and the metal bridges 342 and 344 couple the winding of the second turns together. The second turns have a symmetrical pattern and is similar to the winding of the first turns 332. As one of average skill in the art will appreciate, the first and second turns may include more or less turns, and additional turns may also be disposed on additional dielectric layers.

FIG. 14 is a flowchart representation of a method in accordance with an embodiment of the present invention. In particular a method is presented for use with one or more features or functions presented in conjunction with FIGS. 1-13. In step 400, at least one first turn is created on a first dielectric layer on a substrate. In step 402, at least one via is created and coupled to the at least one first turn. In step 404, at least one second turn is created on a second dielectric layer, and coupled to the first dielectric layer and the at least one via. In step 406, at least one removed dielectric section is removed by removing a portion of the first dielectric between the at least one first turn and the at least one second turn, improving the magnetic coupling between the at least one first turn and the at least one second turn.

In an embodiment of the present invention, step 400 includes creating a plurality of first turns on the first dielectric layer and at least one metal bridges on a third dielectric layer, step 404 includes creating a plurality of second turns on the second dielectric layer and at least one metal bridge on a fourth dielectric layer, and step 406 includes removing a portion of the third dielectric between the at least one first turn and the at least one second turn. Further, step 406 can include retaining a portion of the first dielectric layer that provides support for the at least one first turn. Also, step 400 can include creating a first interwoven spiral-type winding and 404 can include creating a second interwoven spiral-type winding. In addition, step 406 can include using a microelectromechanical systems (MEMS) technology such as dry etching, wet etching, or electro discharge machining.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors discussed above may be field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A voice, data and radio frequency (RF) integrated circuit (IC) comprising:
an RF transmitter, having an output, that generates a transmit signal from outbound data;
an RF receiver that generates inbound data from a received signal;
an on-chip inductor, coupled to an antenna element and to one of the RF transmitter and the RF receiver, wherein the on-chip inductor tunes the antenna element and wherein the on-chip indictor includes:
at least one first turn on a first dielectric layer;
at least one via, coupled to the at least one first turn; and
at least one second turn, coupled to the first dielectric layer and the at least one via, the at least one second turn on a second dielectric layer;
wherein the first dielectric layer includes at least one removed dielectric section where a portion of the first dielectric is removed between the at least one first turn and the at least one second turn, improving the magnetic coupling between the at least one first turn and the at least one second turn.

2. The voice, data and RF IC of claim 1, wherein the at least one first turn includes a plurality of first turns on the first dielectric layer and at least one metal bridges on a third dielectric layer, wherein the at least one second turn includes a plurality of second turns on the second dielectric layer and at least one metal bridge on a fourth dielectric layer, and wherein the at least one removed dielectric section includes a portion where the third dielectric is removed between the at least one first turn and the at least one second turn.

3. The voice, data and RF IC of claim 1, wherein the at least one removed dielectric section includes a plurality of removed dielectric sections separated by portions of the first dielectric layer that provide support for the at least one first turn.

4. The voice, data and RF IC of claim 1 wherein the at least one first turn includes a first interwoven spiral-type winding and the at least one second turn includes a second interwoven spiral-type winding.

5. The voice, data and RF IC of claim 1 wherein the at least one removed dielectric section is formed using a microelectromechanical systems (MEMS) technology.

6. The voice, data and RF IC of claim 5 wherein the microelectromechanical systems (MEMS) technology includes, one of a dry etching, a wet etching and an electro discharge machining.

7. A method of manufacturing an on-chip inductor comprises:
creating at least one first turn on a first dielectric layer on a substrate;
creating at least one via, coupled to the at least one first turn; and
creating at least one second turn on a second dielectric layer, coupled to the first dielectric layer and the at least one via;
removing at least one removed dielectric section where a portion of the first dielectric is removed between the at least one first turn and the at least one second turn, improving the magnetic coupling between the at least one first turn and the at least one second turn.

8. The method of claim 7, wherein the step of creating the at least one first turn includes creating a plurality of first turns on the first dielectric layer and at least one metal bridges on a third dielectric layer, wherein the step of creating the at least one second turn includes creating a plurality of second turns on the second dielectric layer and at least one metal bridge on a fourth dielectric layer, and wherein the step of removing the at least one removed dielectric section includes removing a portion of the third dielectric between the at least one first turn and the at least one second turn.

9. The method of claim 7, wherein the step of removing the at least one removed dielectric section includes retaining a portion of the first dielectric layer that provide support for the at least one first turn.

10. The method of claim 7 wherein the step of creating the at least one first turn includes creating a first interwoven spiral-type winding and the step of creating the at least one second turn includes creating a second interwoven spiral-type winding.

11. The method of claim 7 wherein the step of removing the at least one removed dielectric section includes using a microelectromechanical systems (MEMS) technology.

12. The method of claim 11 wherein the microelectromechanical systems (MEMS) technology includes, one of a dry etching, a wet etching and an electro discharge machining.

13. A voice, data and radio frequency (RF) integrated circuit (IC) comprising:
an RF transmitter, having an output, that generates a transmit signal from outbound data;
an RF receiver that generates inbound data from a received signal;
an on-chip inductor, coupled to one of the RF transmitter and the RF receiver, wherein the on-chip indictor includes:
at least one first turn on a first dielectric layer;
at least one via, coupled to the at least one first turn; and
at least one second turn, coupled to the first dielectric layer and the at least one via, the at least one second turn on a second dielectric layer;
wherein the first dielectric layer includes at least one removed dielectric section where a portion of the first dielectric is removed between the at least one first turn and the at least one second turn, improving the magnetic coupling between the at least one first turn and the at least one second turn.

14. The voice, data and RF IC of claim 13, wherein the at least one first turn includes a plurality of first turns on the first dielectric layer and at least one metal bridges on a third dielectric layer, wherein the at least one second turn includes a plurality of second turns on the second dielectric layer and at least one metal bridge on a fourth dielectric layer, and wherein the at least one removed dielectric section includes a portion where the third dielectric is removed between the at least one first turn and the at least one second turn.

15. The voice, data and RF IC of claim 13, wherein the at least one removed dielectric section includes a plurality of removed dielectric sections separated by portions of the first dielectric layer that provide support for the at least one first turn.

16. The voice, data and RF IC of claim 13 wherein the at least one first turn includes a first interwoven spiral-type winding and the at least one second turn includes a second interwoven spiral-type winding.

17. The voice, data and RF IC of claim 13 wherein the at least one removed dielectric section is formed using a microelectromechanical systems (MEMS) technology.

18. The voice, data and RF IC of claim 17 wherein the microelectromechanical systems (MEMS) technology includes, one of a dry etching, a wet etching and an electro discharge machining.

19. An on-chip inductor comprises:
at least one first turn on a first dielectric layer;
at least one via, coupled to the at least one first turn; and
at least one second turn, coupled to the first dielectric layer and the at least one via, the at least one second turn on a second dielectric layer;
wherein the first dielectric layer includes at least one removed dielectric section where a portion of the first dielectric is removed between the at least one first turn and the at least one second turn, improving the magnetic coupling between the at least one first turn and the at least one second turn.

20. The on-chip inductor of claim 19, wherein the at least one first turn includes a plurality of first turns on the first dielectric layer and at least one metal bridges on a third dielectric layer, wherein the at least one second turn includes a plurality of second turns on the second dielectric layer and at least one metal bridge on a fourth dielectric layer, and wherein the at least one removed dielectric section includes a portion where the third dielectric is removed between the at least one first turn and the at least one second turn.

21. The on-chip inductor of claim 19, wherein the at least one removed dielectric section includes a plurality of removed dielectric sections separated by portions of the first dielectric layer that provide support for the at least one first turn.

22. The on-chip inductor of claim 19 wherein the at least one first turn includes a first interwoven spiral-type winding and the at least one second turn includes a second interwoven spiral-type winding.

23. The on-chip inductor of claim 19 wherein the at least one removed dielectric section is formed using a microelectromechanical systems (MEMS) technology.

24. The on-chip inductor of claim 23 wherein the microelectromechanical systems (MEMS) technology includes, one of a dry etching, a wet etching and an electro discharge machining.
